(19) United States
(12) Patent Application Publication
(10) Pub. No.: US 2008/0119138 A1
(43) Pub. Date: May 22, 2008

(54) BLUETOOTH HEADSET WITH BUILT-IN ANTENNA MODULE

(75) Inventors: Joo-Hyun Kim, Seoul (KR); Ju-Sang Park, Suwon-si (KR); Sung-Yoon Hwang, Yongin-si (KR); Hong-Chul Kim, Suwon-si (KR); Kye-Yong Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/937,998

(22) Filed: Nov. 9, 2007

(30) Foreign Application Priority Data
Nov. 13, 2006 (KR) 2006-0111542

(51) Int. Cl. H04B 7/00; H04M 1/00

(52) U.S. Cl. 455/41.2; 455/575.2

(57) ABSTRACT

A Bluetooth headset is disclosed that includes a body having a microphone and an earphone having a Bluetooth module therein; an ear hook having a curved shape, fixed to the body, and worn on a user's ear; and an antenna module disposed to the ear hook. The antenna module includes an antenna radiator mounted inside the ear hook; and an electrical connection element which is electrically connected to the antenna radiator, is drawn out from one connection end of the body of the ear hook, and is power-fed by the Bluetooth module included in the body.

### PRIORITY

This application claims priority under 35 U.S.C. § 119 to an application filed in the Korean Intellectual Property Office on Nov. 13, 2006 and assigned Serial No. 2006-111542, the contents of which are incorporated herein by reference.

### BACKGROUND OF THE INVENTION

1. Field of the Invention

The present invention relates to a Bluetooth® (hereinafter “Bluetooth”) headset with a built-in antenna module, and, in particular, to a Bluetooth headset with a built-in antenna module to provide a slim-sized headset by effectively utilizing a space for mounting the antenna module without affecting functions of the antenna module.

2. Description of the Related Art

The development of a variety of electronic communication industries has resulted in a widespread use of portable terminals. To satisfy user demand, the portable terminals must provide multiple-functions while decreasing size and weight, promoting the development of peripheral devices attached or added to a portable terminal. Examples of the peripheral devices include a camera provided in an attachable manner or in a built-in manner, a smart card provided as an auxiliary memory, an ear-microphone equipped in the portable terminal to be used for a communication purpose, and a Bluetooth headset by which communication is wirelessly achieved by the aid of a Bluetooth module included in the portable terminal.

In addition to a communication main antenna device, a portable terminal having a Bluetooth function includes an independent Bluetooth antenna module for operating in a frequency band of 2.4 GHz. The Bluetooth module is mounted on a main board of the portable terminal so as to communicate with a Bluetooth headset through a Wireless Local Area Network (WLAN).

Since a portable terminal employing the Bluetooth headset is used in a hands-free manner, there is no need to connect an additional cable to the portable terminal, thereby facilitating convenience in use of the portable terminal. In addition, the portability of the Bluetooth headset is better than that of a general hands-free wired ear-microphone.

The Bluetooth headset includes an antenna radiator to communicate with a portable terminal through a WLAN. Conventionally, one or more Surface Mount Device (SMD) type chip-antennas are mounted on a circuit board of the headset. In general, a chip-antenna is constructed with a coil wound a certain number of turns so as to resonate at a specific frequency band.

However, the conventional Bluetooth headset having the aforementioned structure has a problem in that, since the antenna radiator is disposed on the circuit board included in the headset, a space for mounting the antenna is additionally required, which adversely affects the realization of a slim sized headset.

### SUMMARY OF THE INVENTION

The present invention provides a Bluetooth headset with a built-in antenna module capable of performing a desired function without having to providing an extra space for mounting the antenna module inside the headset.

The present invention also provides a Bluetooth headset with an antenna module having a structure in which the antenna module is not disposed on a circuit board of the headset, thereby facilitating the realization of a slim-sized headset.

According to one aspect of the present invention, there is provided a Bluetooth headset with a built-in antenna module, including a body having a microphone and an earphone and including a Bluetooth module therein; an ear hook having a curved shape, fixed to the body, and worn on a user's ear; and an antenna module disposed to the ear hook, wherein the antenna module includes an antenna radiator mounted inside the ear hook; and an electrical connection element which is electrically connected to the antenna radiator, is drawn out from one connection end of the body of the ear hook, and is power-fed by the Bluetooth module included in the body.

Since the antenna module is not included in the body of the Bluetooth headset, an extra space for mounting the antenna module is not necessary. Therefore, this space can be used to mount other electrical components without increasing the size of the headset, thereby facilitating the realization of a slim-sized headset.

Preferably, the Bluetooth antenna module of the present invention employs the ear hook as a fixing element of the headset, wherein the ear hook is fixed to the headset to be worn on the user's ear. The ear hook is sufficient in the use of an antenna radiator having a length of λ/4 and operating at a frequency band of 2.4 GHz.

Preferably, the antenna module of the present invention can vary depending on the material and the configuration of the ear hook. The antenna module is in a preferred embodiment fixed to the ear hook by insert-molding. In a preferred embodiment, a cavity is formed in the hear hook so that the antenna module can be fixed inside the cavity.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a Bluetooth headset according to the present invention;

FIG. 2 is a schematic cross-sectional view of a Bluetooth headset with a built-in antenna module according to the present invention;

FIG. 3 illustrates a built-in antenna module assembled with an ear hook according to the present invention;

FIG. 4 is a perspective view of an ear hook using an antenna according to an embodiment of the present invention; and

FIG. 5 is a perspective view of an ear hook using an antenna according to another embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

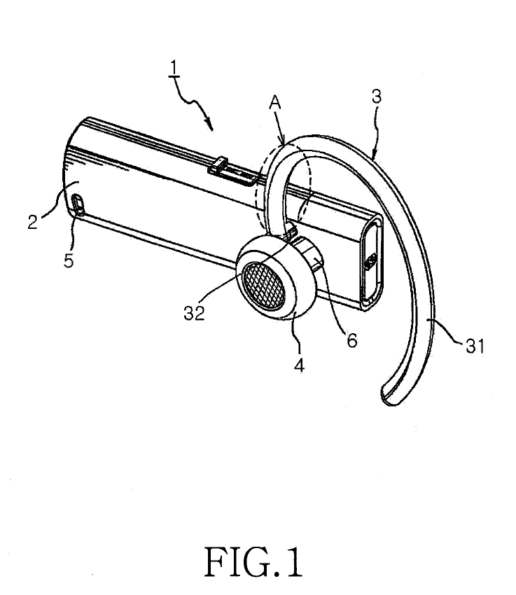

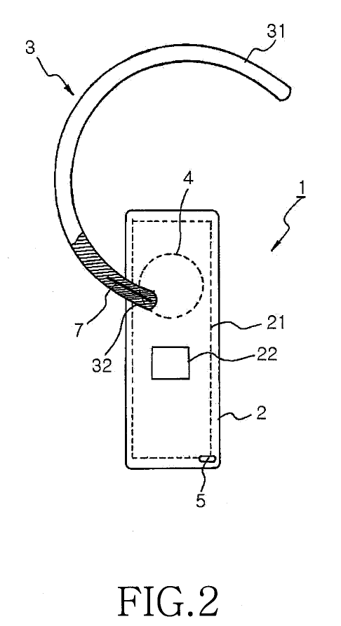

FIG. 1 is a perspective view of a Bluetooth headset according to the present invention and FIG. 2 is a schematic cross-sectional view of a Bluetooth headset with a built-in antenna module according to the present invention. Referring to the figures, the Bluetooth headset includes a body 2 and an ear hook 3 protruding from the body 2 with a certain radius of curvature.

Although the body 2 is shown in a preferred embodiment having a rectangular shape in the figures, the shape of the body 2 is not limited thereto. Thus, the body 2 may have other various shapes in practice. A microphone 5 is disposed to one end of the body 2. The other end of the body 2 is provided with an earphone 4 protruding from a neck portion 6. Preferably, the microphone 5 and the earphone 4 can be separated from each other as far as possible to avoid mutual interference therebetween. As shown in FIG. 2, a circuit board 21 is included in the body 2, and a Bluetooth module 22 is mounted on the circuit board 21 to communication with surrounding terminals through a Wireless Local Area Network (WLAN). An antenna module (or antenna radiator) 7 is disposed to an outer portion of the body 2 and is power-fed by the Bluetooth module via an electrical connection element.

The ear hook 3 is preferably formed to have a specific radius of curvature to be properly positioned in the body 2. The ear hook 3 has a shape that can be worn on the user's ear. Preferably, the ear hook 3 is disposed to the body 2 in a portion around the earphone 4. Although the ear hook 3 may be fixedly disposed to the body 2, more preferably, the ear hook 3 is rotatably disposed to the body 2 so that, when it is not used, the ear hook 3 can rotate properly to minimize a total size of a Bluetooth headset 1, thereby facilitating the portability of the Bluetooth headset 1.

The ear hook 3 includes a hook portion 31 having a specific radius of curvature to be worn on the user's ear and a fixing portion 32 fixed to the body 2. The hook portion 31 and the fixing portion 32 are formed in an integral manner. Preferably, in order to use the antenna module 7 of the present invention, a portion of the ear hook 3 proximal to the neck portion 6 is made of a rigid or flexible synthetic resin material.

The built-in antenna module 7 is provided to achieve Bluetooth communication according to the present invention and is included in the ear hook 3. Preferably, the antenna module 7 is disposed to a portion “A” indicated by a dotted line in FIG. 1. The portion A is defined as a portion where the body 2 and the ear hook 3 are fixed. When the antenna module 7 is disposed to the portion A, the electrical connection element to be described below can be easily introduced into the body 2.

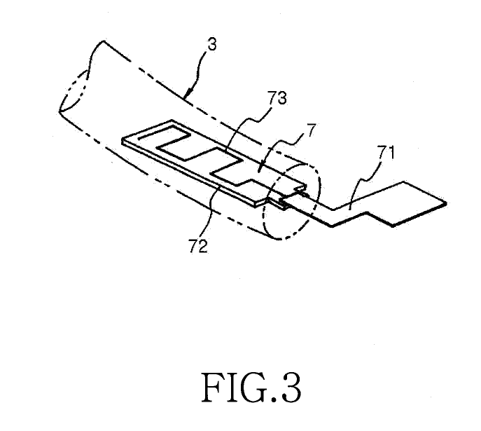

FIG. 3 illustrates the built-in antenna module 7 assembled with the ear hook 3 wherein the antenna module 7 is fixedly mounted inside the ear hook 3 at one end portion of the ear hook 3.

Referring to FIG. 3, the radiator of the antenna module 7 fixed to the ear hook 3 is constructed to form a pattern 73 on a circuit board 72 to have a specific form. Preferably, in FIG. 3, the circuit board 72 is fixed inside the ear hook 3. A Flexible Printed Circuit (FPC) 71 is in a preferred embodiment used as the electrical connection element. One end of the FPC 71 is electrically connected to the pattern 73 at one end of the circuit board 72 preferably by soldering. The other end of the FPC 71 is drawn out of the ear hook 3 by a sufficient length. The drawn portion is inserted into the body 2 and is thus electrically power-fed by the Bluetooth module.

However, the present invention is not limited thereto. For example, as the antenna radiator, only one metal radiation plate may be provided inside the ear hook 3, wherein the metal radiation plate has a specific pattern according to a specific slot. Besides the FPC 71, a fine-wire cable may also be used as the electrical connection element.

As will be described below, the antenna radiator and the electrical connection element may vary depending on the configuration of the ear hook 3 which will be now described.

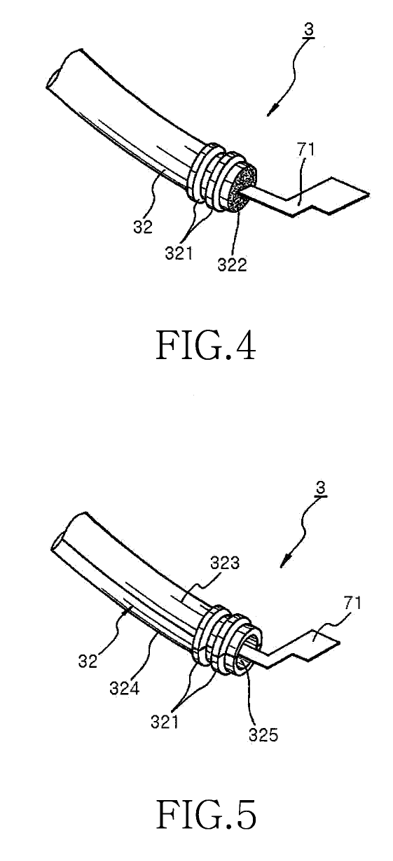

FIG. 4 is a perspective view of the ear hook 3 using an antenna according to an embodiment of the present invention. In FIG. 4, only the fixing portion 32 of the ear hook 3 is depicted. A body fixing portion 321 enables the ear hook 3 to be fixed to the body 2.

Referring to FIG. 4, if the ear hook 3 is constructed of one injection-molded product, the antenna radiator of the present invention may be constructed such that the radiator can be inserted by insert-molding when an injection-molding process is carried out. Preferably, in this process, one end of the FPC 71 protrudes out of the ear hook 3 by a length that is sufficient for the antenna radiator to be inserted into the body 2.

FIG. 5 is a perspective view of the ear hook 3 using an antenna according to another embodiment of the present invention. In FIG. 5, the ear hook 3 is constructed of an upper case frame 323 and a lower case frame 324 which are bonded with each other.

Referring to FIG. 5, a cavity 325 is formed when the upper and lower case frames 323 and 324 constituting the ear hook 3 are bonded with each other. The antenna radiator according to the present invention is inserted into the cavity 325 so as to be fixed therein. Although not shown, the antenna radiator is fixed inside the cavity 325. For example, when using a circuit board having a radial pattern, the antenna radiator is fixed utilizing a bushing formed in the injection-molding process of the upper and lower case frames 323 and 324. When one metal radiation plate is used, in addition to using the bushing, the antenna radiator may be fixed by utilizing a filling material such as epoxy foam after placing the metal radiation plate to an inner portion of the cavity 325. In the present invention, it is important that the antenna radiator is disposed inside the ear hook 3.

As described with reference to FIG. 4, the body fixing portion 321 is also used to fix the ear hook 3 to the body 2.

According to a Bluetooth headset of the present invention, since an antenna module is included in an ear hook, an extra space for mounting the antenna module is not necessary in a headset body. Therefore, there is an advantage in that the Bluetooth headset can be manufactured in a slim size.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A Bluetooth headset with a built-in antenna module, comprising:
a body having a microphone and an earphone with a Bluetooth module therein;
an ear hook that is fixed to the body and worn on a user's ear; and
an antenna module disposed to the ear hook and electrically connected to the Bluetooth module.

2. The Bluetooth headset of claim 1, wherein the antenna module includes:
an antenna radiator mounted inside the ear hook, and
an electrical connection element which is electrically connected to the antenna radiator, is drawn out from one connection end of the body of the ear hook, and is power-fed by the Bluetooth module included in the body.

3. The Bluetooth headset of claim 2, wherein the ear hook includes a hook portion having a specific radius of curvature and a fixing portion fixed to the body of the headset, and
wherein the antenna radiator is disposed inside the hook portion of the ear hook.

4. The Bluetooth headset of claim 3, wherein the ear hook is made of a synthetic resin material.

5. The Bluetooth headset of claim 4, wherein the antenna radiator is insert-molded by subjecting the ear hook to an injection-molding process.

6. The Bluetooth headset of claim 4, wherein the ear hook is constructed of an upper case frame and a lower case frame, and
wherein the antenna radiator is mounted in a cavity formed by the upper and lower case frames.

7. The Bluetooth headset of claim 2, wherein the electrical connection element is a Flexible Printed Circuit (FPC) or a fine-wire cable of which one end is electrically connected to the antenna radiator and another end is electrically power-fed by the Bluetooth module included in the body.

8. The Bluetooth headset of claim 2, wherein the antenna radiator is a metal plate having a specific shape.

9. The Bluetooth headset of claim 8, wherein the electrical connection element is electrically connected to one end of the metal plate by soldering.

10. The Bluetooth headset of claim 2, the antenna radiator has a pattern formed on a dielectric circuit board having a specific shape with a specific width.

11. The Bluetooth headset of claim 10, wherein the electrical connection element is soldered to electrically connect to one end of the pattern formed on the dielectric circuit board.
